(19) United States
(12) Patent Application Publication
(10) Pub. No.: US 2009/0271156 A1
(43) Pub. Date: Oct. 29, 2009

(54) APPARATUS AND METHOD FOR GENERATING ANALYSIS MODEL

(75) Inventor: Masaru Kageura, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/430,727

(22) Filed: Apr. 27, 2009

(30) Foreign Application Priority Data
Apr. 28, 2008 (JP) 2008-117543

(51) Int. Cl. G06F 17/50

(52) U.S. Cl. 703/1

(57) ABSTRACT

A shape of an analysis target is partitioned into partitioned shapes using CAD information data for the analysis target, and adjacent-relationship information indicating an adjacent relationship between the partitioned shapes is generated. Then, a modeling type to be performed on each of the partitioned shapes is set. Then, a mid-surface for a partitioned shape in which a shell is set as the modeling type is extracted. Then, the adjacent-relationship information is referred to, and two or more mid-surfaces extracted from adjacent partitioned shapes are integrated into a combined mid-surface. Then, a shell mesh for the combined mid-surface and a solid mesh for a partitioned shape in which a solid is set as the modeling type are created. The adjacent-relationship information is referred to, and constraint elements that link a shell mesh and a solid mesh that are adjacent to each other are inserted.

### BACKGROUND OF THE INVENTION

1. Field of the Invention

The present invention relates to an apparatus and method for generating an analysis model suited for computer aided engineering (CAE) utilizing numerical analysis simulation using a calculator.

2. Description of the Related Art

In designing an object, numerical analysis simulation using a calculator is performed on the designed object, and the design is examined based on the analysis. In particular, in analyzing structure and vibration of a thin-walled part that mostly has a thin-wall shape having an invariant thickness, such as an injection mold or sheet-metal part, in terms of calculation time and storage capacity, mid-surfaces of a part shape is created, and its shell mesh is used for analysis in many cases.

There are various methods for automatically extracting a mid-surface from a CAD model of an object to lighten the load of users when creating the mid-surface.

With a method described in U.S. Pat. No. 7,376,540, among surfaces forming a geometric model, two surfaces that have a distance equal to or smaller than an input dimension of a reference plate thickness are recognized as a pair of surfaces. The surfaces constituting the pair of surfaces are recognized as a front side surface, a back side surface, and a rib surface. An offset surface is created for each pair of surfaces, and the offset surfaces are stitched into a mid-surface.

With a method described in U.S. Patent Application Publication No. 2004/0111243, tetrahedral solid elements are generated from an input three-dimensional geometric model, and the intermediate nodes in the vicinity of a mid-surface in the direction of plate thickness in each solid element are connected to generate a triangular or rectangular shell element, and a shell mesh on the mid-surface is thus generated.

With a method described in Japanese Patent Laid-Open No. 4-350774, an input three-dimensional geometric model is partitioned into simple three-dimensional shapes, and a mid-surface is generated for each of the simple three-dimensional shapes.

However, the method described in U.S. Pat. No. 7,376,540 still has a problem in which portions that are not recognized as a pair of surfaces remain in a case where a target part has a complex shape, such as an injection mold. Examples of the case where the part has a complex shape include a case where the part includes a thick-walled portion and thus the value of the wall thickness is inconstant, a case where the rib is tapered, and a case where the part includes a thick-walled portion, such as a solid boss.

The method described in U.S. Patent Application Publication No. 2004/0111243 has a problem in which it is difficult to automatically form a single-layer tetrahedral mesh on the entire area of a target part in a case where the target part has a complex shape, such as an injection mold. Examples of the case where the target part has a complex shape include a case where the part has an inconstant thickness and a case where the part has ribs disposed in a complex arrangement.

The method described in Japanese Patent Laid-Open No. 4-350774 has a problem in which it is difficult to divide a complex shape, such as the shape of an injection mold casing part, into simple three-dimensional shapes and a large number of man-hours is needed to provide instructions by an operator. In addition, because this method does not have a unit for integrating mid-surfaces generated from simple three-dimensional shapes, it is necessary to manually integrate mid-surfaces calculated for simple three-dimensional shapes in order to generate a mesh to be finally used in analysis.

These traditional methods also have a problem in which it is difficult to generate a composite analysis model that includes both shell models and solid models from CAD information data for a single part. For structural analysis and vibration analysis, it may be preferable to generate a composite analysis model that includes both a shell mesh and a solid mesh, even when the target is a thin-walled part, if the part has a portion that would lead to decreased accuracy of analysis without modeling using a solid mesh, such as a solid boss. A solid mesh and a shell mesh can be integrated by use of sharing nodes on the border of a connection and can also be integrated by creating constraint elements between nodes of the connection, such as a multi-point constraint (MPC), as illustrated in FIG. 35. However, the methods described in the above-mentioned first and second U.S. patent documents have difficulty in changing the modeling technique according to the sections of a part shape in generating such a composite model. The method described in the above-mentioned third Japanese patent document can change the modeling technique according to the simple three-dimensional shapes obtained by partitioning, but cannot automatically integrate meshes generated by modeling thereof.

The methods described in the first and second U.S. patent documents also have a problem in which a small element is created in a connection of mid-surfaces of a base thin-walled portion and a rib portion. If there is a small element, because of the Courant condition, the value of a time step required for stable calculation in dynamic analysis is proportional to the minimum distance between nodes of a mesh. Accordingly, an analysis requires a larger amount of time step calculation when there are small elements, compared with an analysis having the same time length when there is no such small element, so the time for calculation is significantly long. The small element occurs, for example, if a rib is present in the vicinity of a base thin-walled portion, as illustrated in the left of FIG. 36. In this case, it is preferable to generate an analysis model that produces no small element, for example, an analysis model in which the position of one mid-surface of a rib is moved, as illustrated in the right of FIG. 36. Unfortunately, this cannot be achieved by the methods described in the first and second U.S. patent documents because the mid-surface of the base portion and the mid-surface of the rib portion are integrated while faithfully maintaining their original part shapes, thus causing the small element to occur.

### SUMMARY OF THE INVENTION

The present invention provides a technique for easily generating an analysis model having both shell meshes and solid meshes in response to an instruction from an operator even for a thin-walled part that has a complex shape, such as an injection mold.

According to an aspect of the present invention, an apparatus for generating an analysis model includes a partitioning unit, an adjacent-relationship information generating unit, a setting unit, a mid-surface extracting unit, an integrating unit, a shell-mesh creating unit, a solid-mesh creating unit, and an inserting unit. The partitioning unit is configured to partition a shape of an analysis target into multiple partitioned shapes using CAD information data for the analysis target. The adjacent-relationship information generating unit is configured to generate adjacent-relationship information indicating an adjacent relationship between the multiple partitioned shapes. The setting unit is configured to set a modeling type for each of the multiple partitioned shapes. The mid-surface extracting unit is configured to extract a mid-surface for a partitioned shape in which a shell is set as the modeling type by the setting unit. The integrating unit is configured to refer to the adjacent-relationship information and integrate two or more mid-surfaces extracted from adjacent partitioned shapes into a combined mid-surface. The shell-mesh creating unit is configured to create a shell mesh for the combined mid-surface. The solid-mesh creating unit is configured to create a solid mesh for a partitioned shape in which a solid is set as the modeling type by the setting unit. The inserting unit is configured to refer to the adjacent-relationship information and insert constraint elements that link a shell mesh and a solid mesh that are adjacent to each other.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 is a block diagram that illustrates a configuration of an analysis model generating apparatus (information processing apparatus) according to an embodiment of the present invention.

FIG. 2 is a flowchart that illustrates an operation of the analysis model generating apparatus.

FIG. 3 illustrates one example of a part shape prior to partitioning.

FIG. 4 illustrates how the part shape shown in FIG. 3 is partitioned.

FIG. 5 illustrates one example of a shape in which mid-surfaces do not become a single sheet in terms of topology.

FIG. 6 illustrates one example of mid-surfaces that do not become a single sheet in terms of topology.

FIG. 7 illustrates one example of a partitioned shape (cruciform) prior to separation.

FIG. 8 illustrates a separation boundary surface and a separated boundary surface in the partitioned shape shown in FIG. 7.

FIG. 9 illustrates one example of an ID-pair table.

FIG. 10 illustrates how the partitioned shape shown in FIG. 7 is separated.

FIG. 11 illustrates one example of an adjacent relationship table.

FIG. 12 illustrates one example of a modeling type table.

FIG. 13 illustrates example extracted mid-surfaces.

FIG. 14 illustrates one example of a combined mid-surface.

FIG. 15 illustrates a shell mesh of a combined mid-surface.

FIG. 16 illustrates one example of a solid mesh.

FIG. 17 illustrates how a solid mesh and a shell mesh are integrated.

FIG. 18 is a flowchart that illustrates the details of step S1 of the flowchart of FIG. 2.

FIG. 19 illustrates one example of a side face before the side face is partitioned to a convex shape.

FIG. 20 illustrates how the side face shown in FIG. 19 is partitioned to a convex shape.

FIG. 21 illustrates a method for determining whether surfaces are convexly adjacent.

FIG. 22 illustrates a set of surfaces of partitioned shapes and their boundary edge lines.

FIG. 23 is a flowchart that illustrates the details of step S103 of the flowchart of FIG. 18.

FIG. 24 illustrates a method for determining whether a vertex is concave.

FIG. 25 illustrates extracted concave vertices.

FIG. 26 illustrates division of a boundary loop of a side face.

FIG. 27 is a flowchart that illustrates the details of step S107 of the flowchart of FIG. 18.

FIG. 28 illustrates one example of a partitioned shape prior to separation.

FIG. 29 illustrates how a separation boundary loop is classified.

FIG. 30 is a flowchart that illustrates the details of step S5 of the flowchart of FIG. 2.

FIG. 31 illustrates a relationship between partitioned shapes.

FIG. 32 illustrates how a mid-surface vertex on a separation boundary surface is projected on an adjacent mid-surface.

FIG. 33 illustrates one example of a method for determining the degree of proximity of a vertex projected on an adjacent mid-surface with respect to a previously projected edge and an integrating process.

FIG. 34 illustrates one example of a process for integrating mid-surfaces.

FIG. 35 illustrates one example of a composite model that includes both a solid mesh and a shell mesh.

FIG. 36 illustrates how the position of a mid-surface of a rib is corrected according to a traditional method.

### DESCRIPTION OF THE EMBODIMENTS

Embodiments of the present invention are described below with reference to the accompanying drawings.

### First Embodiment

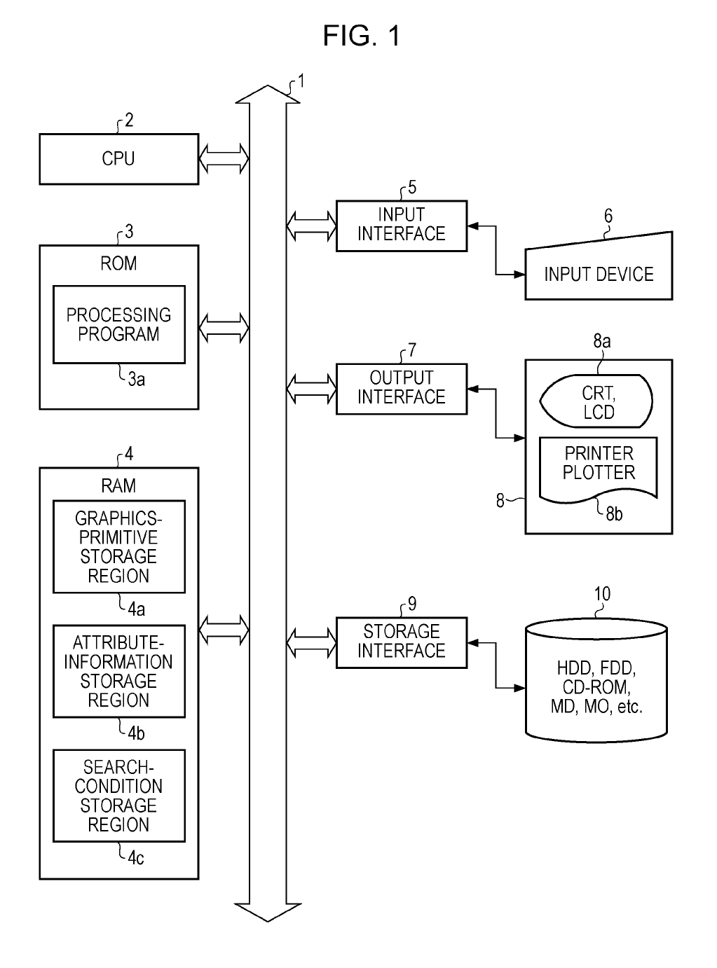

First, a first embodiment of the present invention is described. FIG. 1 is a block diagram that illustrates a configuration of an analysis model generating apparatus (information processing apparatus) according to the first embodiment. The analysis model generating apparatus can generate, for example, an analysis model for use in a finite-element method (FEM) using both a shell element and a solid element that can be utilized in structural analysis and vibration analysis from a CAD model (CAD information data) for a part (analysis target).

As illustrated in FIG. 1, the analysis model generating apparatus includes a central processing unit (CPU) 2 performing a computation, a read-only memory (ROM) 3 (storage) storing a processing program 3a defining a procedure of processing, and a random-access memory (RAM) 4 (storage) including a region that stores data being a target of the processing. The region of the RAM 4 includes a graphics-primitive storage region 4a, an attribute-information storage region 4b, and a search-condition storage region 4c. The analysis model generating apparatus further includes an input interface 5 through which a signal is exchanged with an input device 6, an output interface 7 through which a signal is exchanged with an output device 8, and a storage interface 9 through which a signal is exchanged with a storage 10. Examples of the input device 6 include a keyboard and a mouse. Examples of the output device 8 include a display device 8a and a drawing device 8b. Examples of the drawing device 8b include a printer (printing device) and a plotter. Examples of the storage 10 include a hard disk drive (HDD), a flexible disk drive (FDD), a compact-disk read-only memory (CD-ROM), a minidisk (MD), and a magneto-optical (MO) disk drive. The storage 10 stores data being a target of processing and data being a result of the processing. The CPU 2, ROM 3, RAM 4, input interface 5, output interface 7, storage interface 9 are connected through a data bus 1. The storage 10 may be incorporated in the analysis model generating apparatus.

In using the analysis model generating apparatus having an above-described configuration, a user provides an instruction using the input device 6, and the status of processing in progress and the result of the processing are output through the output device 8. Various kinds of data from the input device 6 or the storage 10 are stored in the RAM 4 through the input interface 5 or the storage interface 9 and the data bus 1. The CPU 2 performs processing in accordance with the procedure of the processing program 3a stored in the ROM 3. Depending on the stage of the processing, data to be temporarily used is stored in the RAM 4, data to be output and saved is stored in the storage 10, and a final output is stored in, for example, a server (not shown) on a network through the data bus 1.

Next, an operation of the analysis model generating apparatus (a method for generating an analysis model) is described. The operation is achieved by processing based on the processing program 3a performed by the CPU 2. Before the details of the operation (processing) are described, its precondition is first described.

The information for a geometric model of a part being a target of the processing (hereinafter referred to sometimes as CAD information) is generated using a CAD system and stored in the RAM 4 or the storage 10. The CAD information relates to the shape of a part and contains geometric information for geometric elements constituting a part shape, such as a surface, an edge, and a vertex, and topology information indicating an adjacent relationship between geometric elements. Each of the geometric elements has an ID for identifying itself. The CPU 2 can extract information for a geometric element identified by specifying the ID thereof.

Here, the geometric information is described. As described above, the geometric information relates to a surface, an edge, and a vertex, which are geometric elements constituting a part shape.

The geometric information relating to a surface contains, for example, type information indicating the type of the surface, such as a flat surface, a cylindrical surface, a spherical surface, a conical shape, and a non uniform rational Basis spline (NURBS) curved surface and geometric identifying information according to the type of the surface. Examples of the geometric identifying information are described below. That is, when the geometric element is a flat surface, the geometric identifying information can be information indicating the coordinate value of any single point passing through the flat surface and that indicating each component of the normal vector; when the geometric element is a cylindrical surface, the geometric identifying information can be information indicating a directional vector of an axis of the cylindrical surface and the coordinate value of any single point through which the axis passes; and when the geometric element is a spherical surface, the geometric identifying information can be information indicating the coordinate value of the center of the spherical surface and that indicating the radius.

The geometric information relating to an edge contains, for example, type information indicating the type of the edge, such as a line segment, a circle, a circular arc, an oval arc, and a NURBS curve and geometric identifying information according to the type of the edge. Examples of the geometric identifying information are described below. That is, when the geometric element is a line segment, the geometric identifying information can be information indicating the coordinate value of the starting point and that of the endpoint; when the geometric element is a circle, the geometric identifying information can be information indicating the coordinate value of the center of the circle, the radius, and a normal vector of a plane in which the circle exists; and when the geometric element is a circular arc, the geometric identifying information can be information indicating the coordinate value of the central point of the circular arc, the radius, a normal vector of a plane in which the circular arc exists, and the coordinate value of the starting point and that of the endpoint.

The geometric information relating to a vertex can be represented by, for example, the coordinate value of the vertex.

In the following description, the geometric information included in a geometric element indicates that the surface is a flat surface only and the edge is a line segment only. However, alternatively, other types of surface and edge may be present.

Next, the topology information is described. As described above, the topology information is information that indicates an adjacent relationship between geometric elements.

Each of the surfaces constituting a geometric element has one or more boundary loops as boundary information. A boundary loop is a row (set) of edge lines arranged in sequence. Adjacent edge lines share a single vertex, and the first and the last edge lines share a single vertex. One of the boundary loops is an external loop indicating the external boundary of a surface. Accordingly, every surface always has a single external loop. A surface may have an internal loop, in addition to the external loop. The internal loop indicates the boundary of a hole in the surface. Each of these loops has the direction of rotation. In accordance with the direction of rotation, edge lines are arranged such that the entity of geometry is present leftward. Thus, when a surface is viewed from the outside of the entity of geometry, the external loop has the counterclockwise direction of rotation, and the internal loop has the clockwise direction of rotation.

The above-described data structure allows edge lines and vertices to be extracted in sequence in accordance with the direction of each boundary loop. Edge lines constituting each surface can be extracted from the surface, and a surface being in contact with each edge line can also be extracted.

A “part shape” input into the analysis model generating apparatus and a “partitioned shape” obtained by partitioning the part shape have adjacent-relationship information for representing “solid” as the topology information, in addition to the above-described CAD information for each surface. The “partitioned shape” used here is a portion of the original “part shape.” A “mid-surface” output from the analysis model generating apparatus has geometric information that represents a surface that can be handled by a typical CAD system and information that indicates the thickness of the surface. The mid-surface may be composed of a plurality of adjacent surfaces. As described above, the surface includes geometric data representing geometric information of a flat surface and a curved surface and also includes boundary-loop information on the boundary loop surrounding the surface.

An FEM model that is an analysis model output from the analysis model generating apparatus is called mesh data and contains information for a vertex called a node and information for an element having a node as a vertex. The information for a node can be represented as, for example, the coordinate value of the point and the degree of freedom of each node. In three dimensions, there are three degrees of freedom for translational motion and three degrees of freedom for rotation, i.e., six degrees of freedom in total. The information for a node has information indicating whether each of the degrees of freedom is effective for each node. The information for an element is represented by the type of the element and information required for that type of the element.

The element handled in the present embodiment contains a triangular element and a rectangular element that represent a surface called a shell element, a tetrahedral element and a hexahedral element that represent a three-dimensional object called a solid element, and a rigid element and a constraint element (e.g., a MPC) that represent a constraint relationship between a node of a shell element and a node of a solid element. The shell element further includes information about a thickness.

In the present embodiment, although the details will be described below, a mid-surface generated from a partitioned shape is integrated with an adjacent mid-surface, and the combined mid-surface is converted into a shell element. When the partitioned shape is specified to be modeled in the form of a solid, it is converted into a solid element. The shell element and the solid element are linked together with a constraint element.

In the present embodiment, the CPU 2 retrieves part shapes from CAD data stored in the RAM 4 or the storage 10 and displays a list of part shapes on the display device 8a. When an operator selects a desired part shape using the input device 6, the CPU 2 performs processing. Data of an analysis model being a result is stored in the RAM 4 or the storage 10, and the result is displayed on the display device 8a. During the processing, as needed, a status in progress is displayed on the display device 8a, and an instruction to an operator is supplied. When an operator inputs a value through the input device 6, the input value is stored in the RAM 4 or the storage 10.

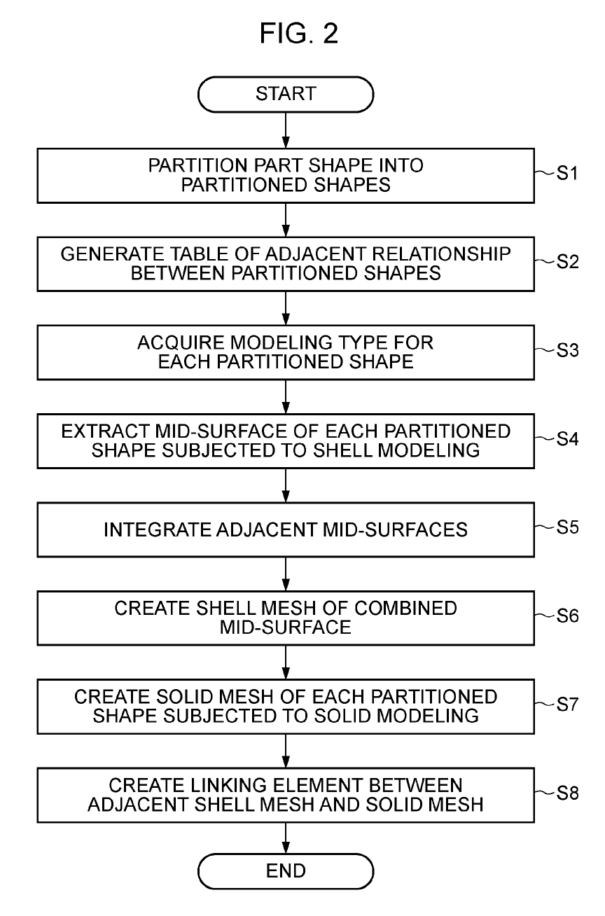

Next, the details of an operation of the analysis model generating apparatus (a method for generating an analysis model) are described below. FIG. 2 is a flowchart that illustrates an operation of the analysis model generating apparatus.

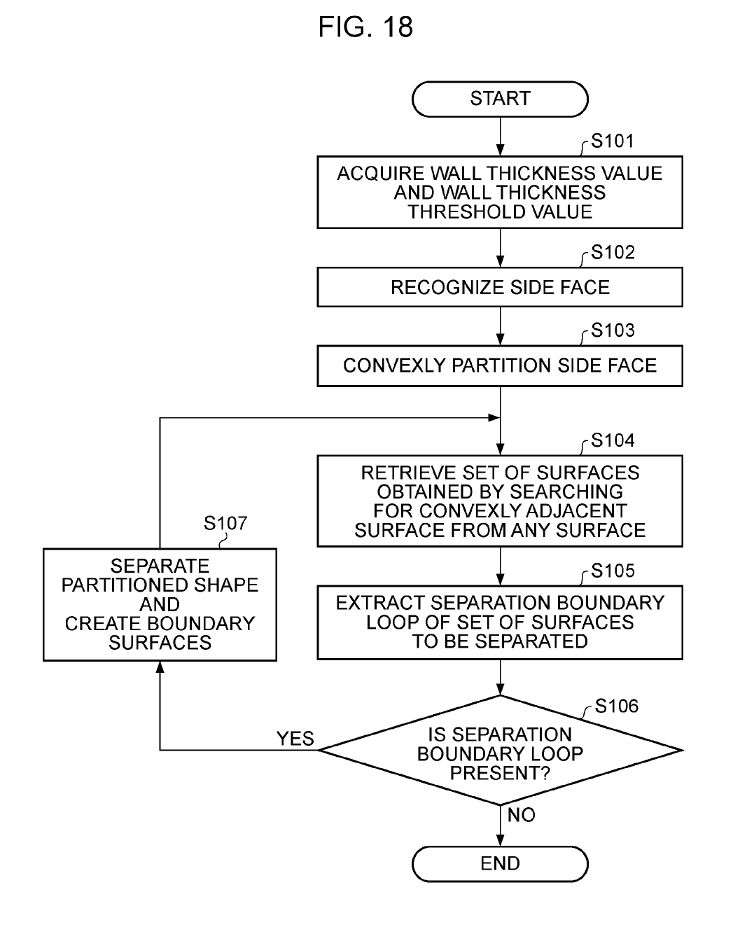

First, in step S1, the CPU 2 partitions a part shape into partitioned shapes on the basis of input geometric information on a part (CAD information). The details of step S1 will be described below with reference to FIG. 18. Briefly, the CPU 2 performs partitioning such that partitioned shapes do not occupy a common space region (i.e., intersection shape is empty) and a unity shape of all partitioned shapes obtained by partitioning will be an original part shape. The CPU 2 partitions a shape to be subjected to shell modeling such that the mid-surface of its obtained partitioned shape is equivalent to the shape of a single sheet surface or a single sheet surface having one or more holes in terms of topology.

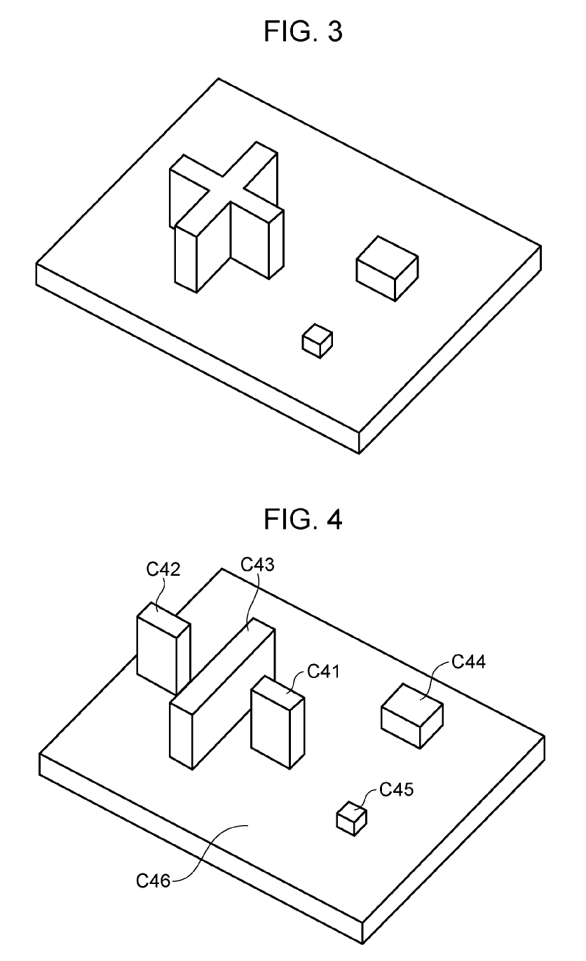

For example, a shape that has a base thin-walled portion (hereinafter referred to as “main wall”) and one or more ribs standing thereon, as illustrated in FIG. 3, can be partitioned into partitioned shapes C41 to C46 illustrated in FIG. 4. In FIG. 4, C46 is the main wall and C41 to C45 are partitioned shapes constituting the ribs.

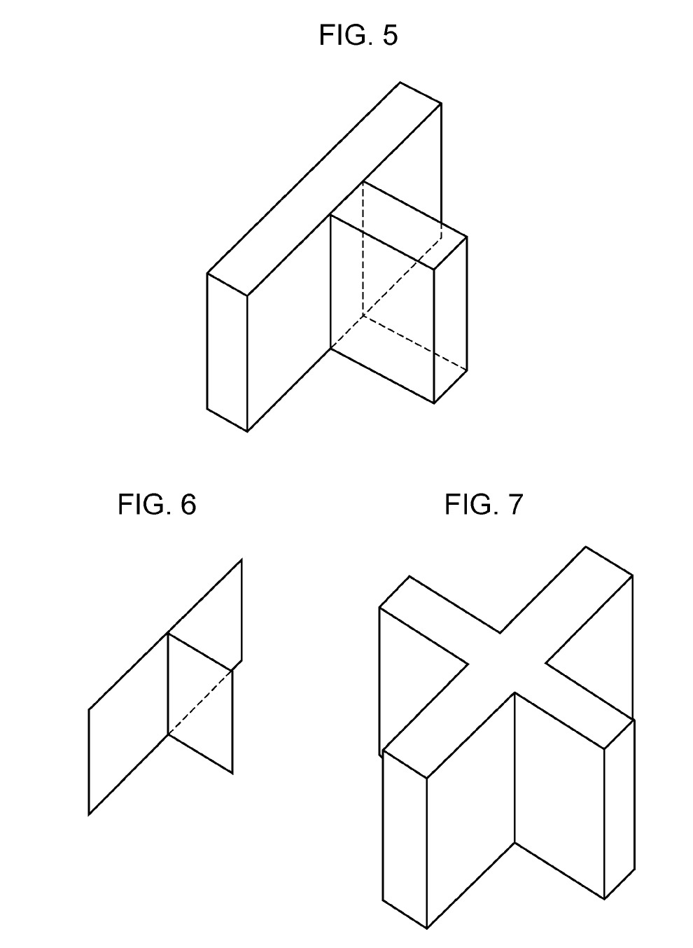

When one cross section of the partitioned shapes obtained by partitioning exhibits a T-shaped form, as illustrated in FIG. 5, the mid-surface does not have the same topology as that of a single sheet, but has a similar topology to that of a composite in which two sheets are joined, as illustrated in FIG. 6. In this case, the CPU 2 performs partitioning again.

After such partitioning, the CPU 2 creates data (A) and (B) indicated below and stores the data in the RAM 4 or the storage 10.
(A) Geometric data of each partitioned shape
(B) An ID-pair table storing “separation boundary surface” and associated “separated boundary surface”

The geometric data in (A) is the above-described geometric information and topology information. The “separation boundary surface” and “separated boundary surface” in (B) are surfaces newly generated on the boundary when a set of surfaces of a portion of a part shape is separated as surfaces constituting a partitioned shape. A surface generated in a separated partitioned shape (separation shape) is referred to as a “separation boundary surface”, and a surface newly generated in the remainder after separation (separated shape) is referred to as a “separated boundary surface.”

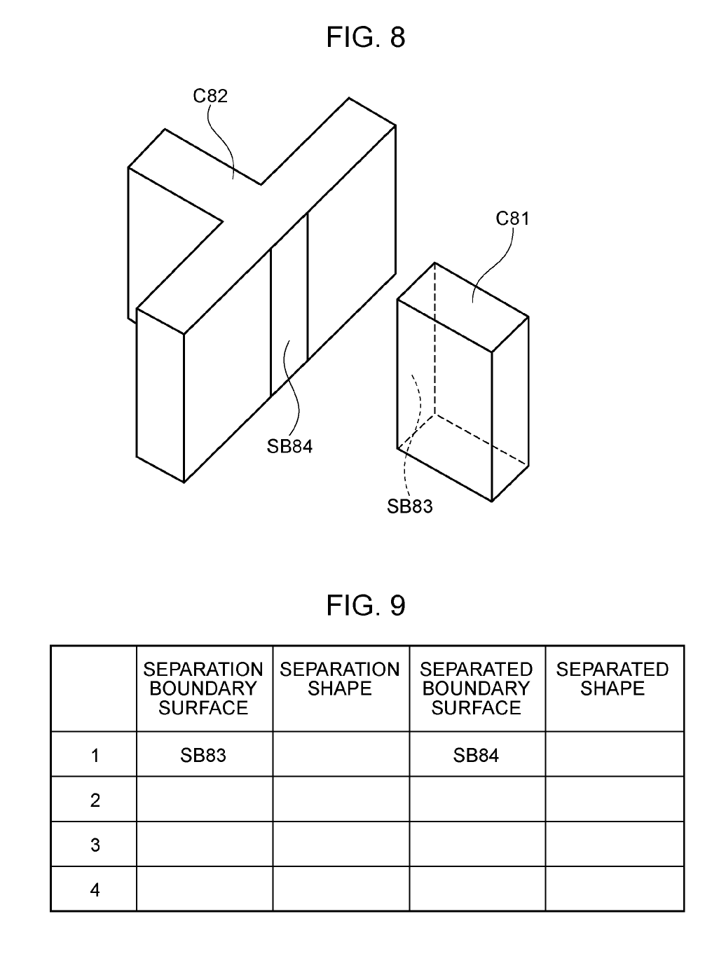

For example, as illustrated in FIG. 8, one case is discussed where the CPU 2 separates a rectangular parallelepiped partitioned shape C81 from a partitioned shape that has a cruciform cross section, as illustrated in FIG. 7, as a “separation shape”, and a partitioned shape C82 having a T-shaped cross section remains as a “separated shape.” In this case, on the separated boundary, a separation boundary surface SB83 is generated in the partitioned shape C81 and a separated boundary surface SB84 is generated in the partitioned shape C82. An ID-pair table illustrated in FIG. 9 is obtained.

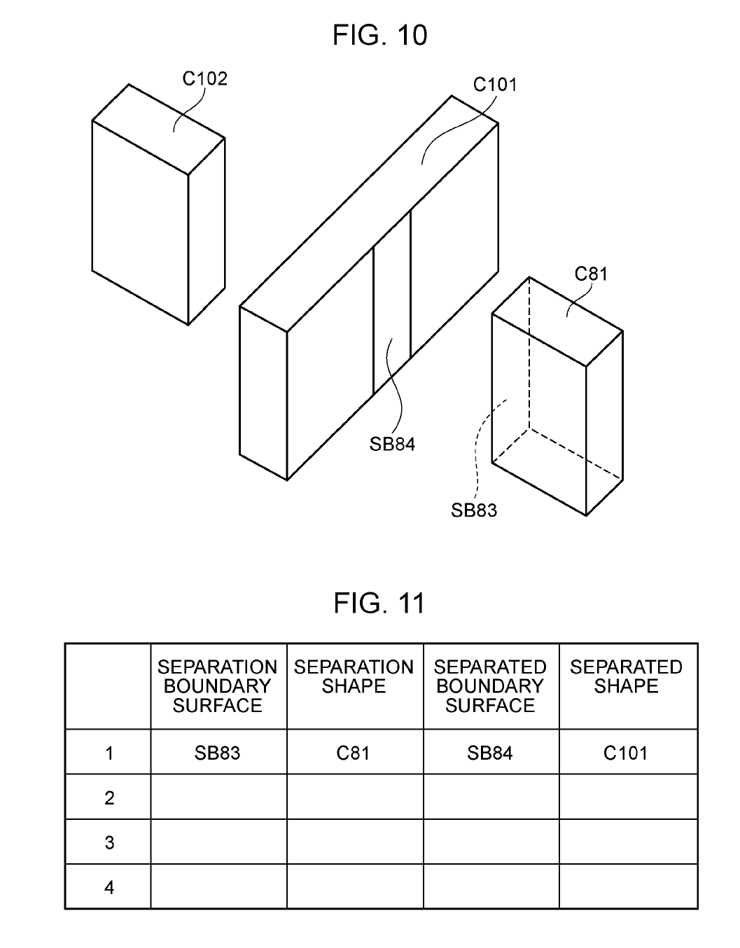

After step S1 in FIG. 2, the CPU 2 registers adjacent-relationship information indicating an adjacent relationship between partitioned shapes obtained by partitioning on the basis of the ID-pair table of “separation boundary surfaces” and associated “separated boundary surfaces” of partitioned shapes in step S2. This processing corresponds to an adjacent-relationship information generating unit. The adjacent-relationship information used here is information that has a pair of an ID of a partitioned shape having the “separation boundary surface” and an ID of a partitioned shape having the “separated boundary surface” when the partitioned shapes are separated and a pair of an ID of a partitioned shape having the “separation boundary surface” and an ID of a partitioned shape having the “separated boundary surface” in the finally partitioned shapes as one set. In generating such adjacent-relationship information, the CPU 2 retrieves a partitioned shape that has a “separation boundary surface” or “separated boundary surface” after separation and additionally registers the ID thereof in the adjacent relationship table generated in step S1. The partitioned shape that has a “separation boundary surface” or “separated boundary surface” can be found through an examination of geometric data of partitioned shapes. For example, a case is discussed where a part shape illustrated in FIG. 7 is partitioned into three partitioned shapes C81, C101, and C102 illustrated in FIG. 10 through partitioning illustrated in FIG. 8. As illustrated in FIG. 8, a partitioned shape that has the separation boundary surface SB83 registered in the adjacent relationship table is C81, and a partitioned shape that has the separated boundary surface SB84 is C101. Accordingly, as illustrated in FIG. 11, the CPU 2 adds the ID of the partitioned shape C81 and the ID of the partitioned shape C101 in the adjacent relationship table illustrated in FIG. 9. Although not illustrated in FIG. 11, the CPU 2 also registers the adjacent relationship between the partitioned shapes C101 and C102. Such adjacent-relationship information indicates, among obtained partitioned shapes, adjacency between partitioned shapes and surfaces of adjacent partitioned shapes.

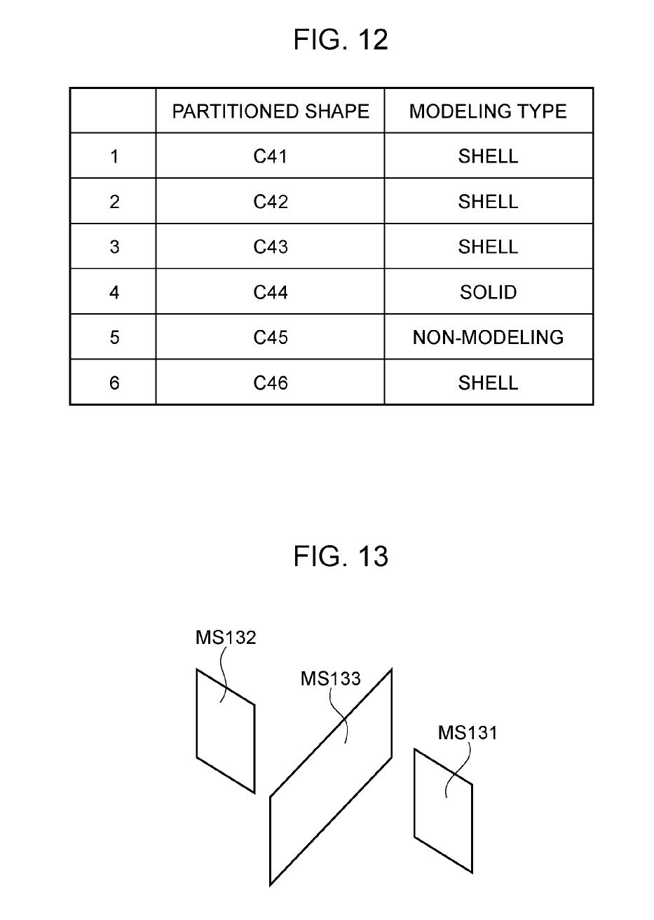

Next, in step S3, the CPU 2 acquires the modeling type set for each of the partitioned shapes obtained by partitioning. At this time, the CPU 2 may acquire information input by an operator using the input device 6 and alternatively may acquire a value automatically determined from geometric data of the partitioned shapes, as the value of the modeling type. In the present embodiment, three modeling types that can be set are (A) shell, (B) solid, and (C) non-modeling. The modeling can also be set using a 1-D element, such as a beam. The “non-modeling” in (C) is a setting in which a geometric element that is unnecessary for analysis, such as a small shape, is removed from modeling targets. After acquiring the modeling type, the CPU 2 generates a modeling type table containing that modeling type and stores it in the RAM 4 or the storage 10. For example, when a part shape illustrated in FIG. 3 is partitioned into partitioned shapes illustrated in FIG. 4, it is assumed that the shell modeling in (A) is set for the partitioned shapes C41, C42, C43, and C46, the solid modeling in (B) is set for the partitioned shape C44, and the non-modeling in (C) is set for the partitioned shape C45. In this case, the CPU 2 generates a modeling type table illustrated in FIG. 12 and stores it in, for example, the storage 10.

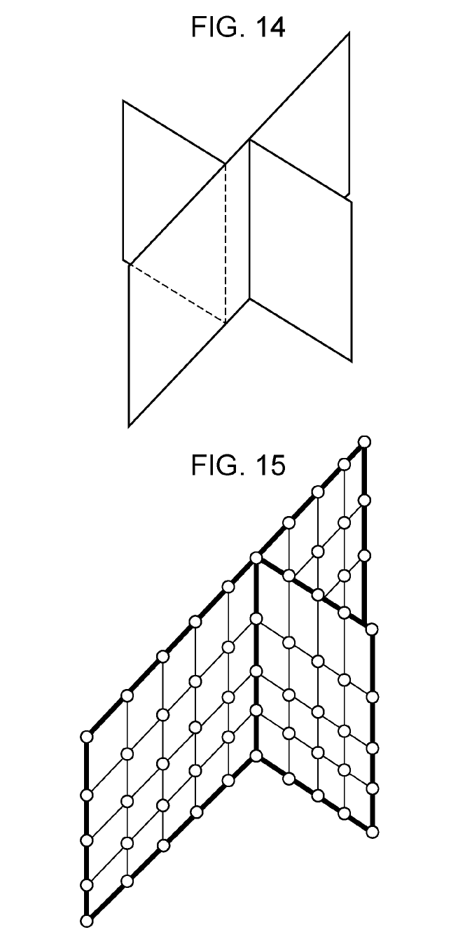

After that, the CPU 2 extracts a mid-surface of a partitioned shape that is set so as to be subjected to the shell modeling, registers a correspondence between the partitioned shape and the extracted mid-surface in the table, and stores it in the RAM 4 or the storage 10 (step S4). This processing corresponds to a mid-surface extracting unit. Because the mid-surface of each partitioned shape being a target of the processing is equivalent to the shape of a single sheet surface or a single sheet surface having one or more holes, the mid-surface can be easily extracted by a traditional technique, for example, that described in the first or second above-mentioned U.S. patent document. For example, when the part shape illustrated in FIG. 7 is partitioned into the partitioned shapes C81, C101, and C102 illustrated in FIG. 10, if the shell modeling is set for them, mid-surfaces MS131, MS132, and MS133 are extracted for the respective partitioned shapes, as illustrated in FIG. 13.

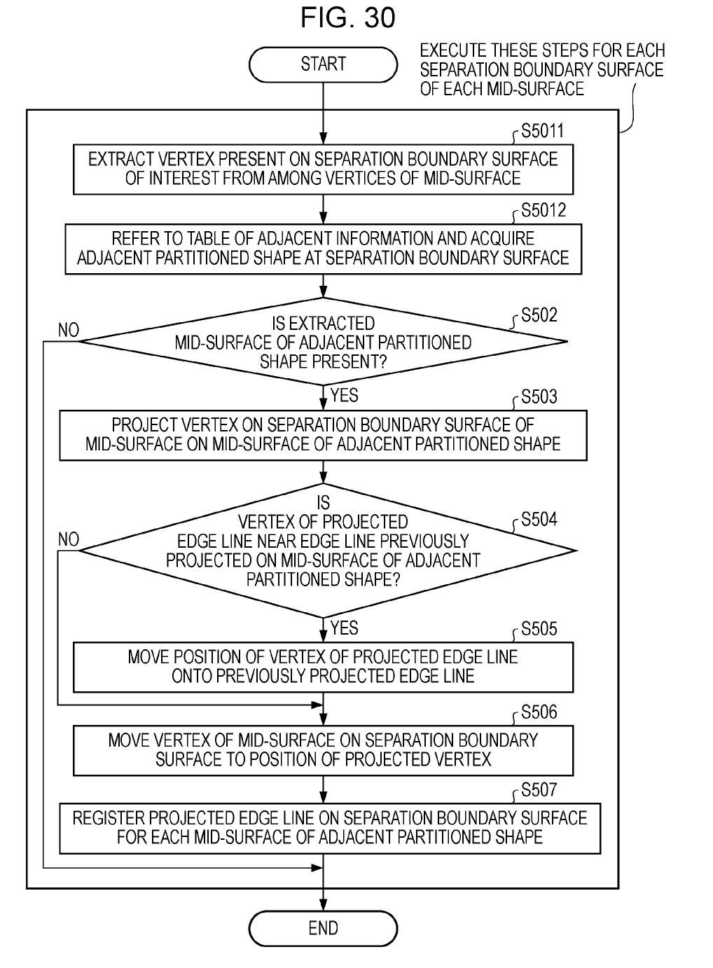

Then, in step S5, the CPU 2 generates a combined mid-surface by integrating adjacent mid-surfaces on the basis of the adjacent relationship table generated in step S2. For example, when the mid-surfaces illustrated in FIG. 13 are extracted in step S4, the CPU 2 integrates the adjacent mid-surfaces MS131 and MS133 and also integrates the adjacent mid-surfaces MS132 and MS133 and thus obtains a combined mid-surface illustrated in FIG. 14. At this time, if the combined mid-surface includes a small element, the CPU 2 corrects the mid-surface. This processing corresponds to a mid-surface correcting unit. The details of this processing will be described below with reference to FIG. 30.

Then, in step S6, the CPU 2 creates a surface mesh of the combined mid-surface generated in step S5 and creates a shell mesh. This processing corresponds to a shell-mesh creating unit. The CPU 2 registers a correspondence between the combined mid-surface and the created surface mesh in the table and stores it the RAM 4 or the storage 10. For example, the CPU 2 creates a shell mesh illustrated in FIG. 15 with respect to a surface mesh of the combined mid-surface illustrated in FIG. 6.

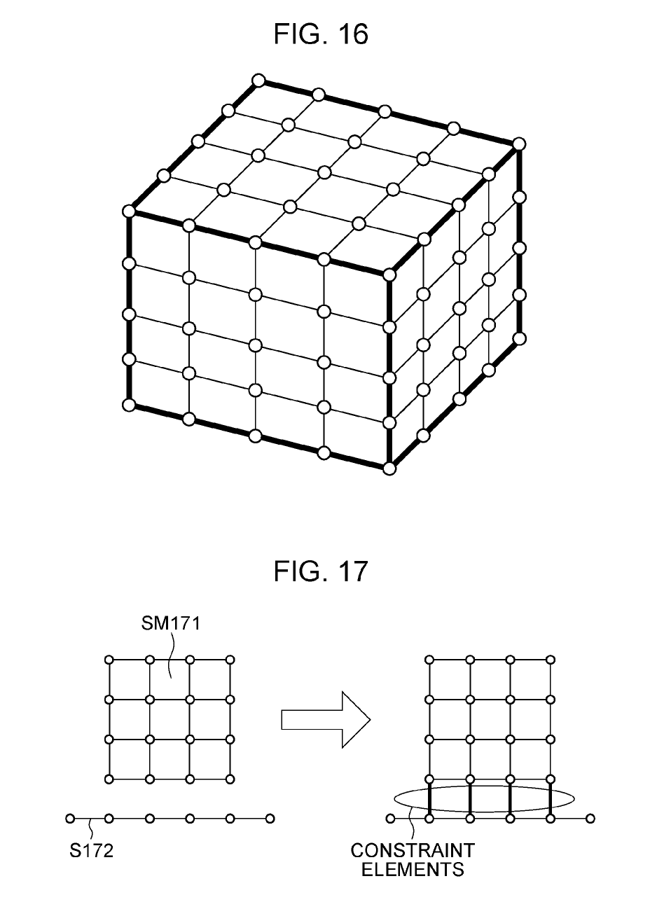

After that, the CPU 2 creates a solid mesh for a partitioned shape that is set so as to be subjected to the solid modeling (step S7). This processing corresponds to a solid-mesh creating unit. The CPU 2 registers a correspondence between the partitioned shape set so as to be subjected to the solid modeling and the solid mesh in the table and stores it in the RAM 4 or the storage 10. For example, the CPU 2 creates a solid mesh illustrated in FIG. 16 with respect to the partitioned shape C44 illustrated in FIG. 4.

In the present embodiment, in steps S6 and S7, the CPU 2 stores, in the RAM 4 or the storage 10, information indicating where in a shape targeted for creation of the mesh the nodes of the created mesh are present. For example, information indicating what surface in a shape targeted for creation of the mesh a certain node is present is stored. Such information is also generated in a process for creating a mesh in a traditional technique.

After step S7, the CPU 2 recognizes an adjacent relationship between the solid mesh and the shell mesh in step S8 on the basis of the adjacent relationship table generated in step S2. The CPU 2 creates a rigid element and a constraint element (e.g., MPC) that link nodes on the separation boundary surface and separated boundary surface of adjacent solid mesh and shell mesh to link the meshes together.

FIG. 17 illustrates an example of a mesh shape in which adjacent solid mesh and shell mesh are linked. The shape illustrated in FIG. 17 is viewed from a side. As illustrated in FIG. 17, in this example, four constraint elements are generated between a solid element SM171 and a shell element SM172. A constraint element can be generated as, for example, an element that links a first node on a separation boundary surface of a solid element with a second node on a shell mesh that is closest to a point in which the first node is projected on the shell mesh. A constraint element can also be generated by creating a mesh such that, in creating a shell mesh in step S6 or a solid mesh in step S7, the mesh has a point (anchor node) obtained by projecting a node on a separation boundary surface on an adjacent mid-surface or part shape and in creating a mesh for an adjacent mid-surface or part shape, the mesh always have, as its own node, the anchor node. In this case, the constraint element can be generated between the node on the separation boundary surface and its associated anchor node.

Next, the details of step S1 of the flowchart illustrated in FIG. 2 are described with reference to FIG. 18.

First, in step S101, the CPU 2 causes an operator to input a value of a wall thickness and a value of a wall thickness threshold using the input device 6 and stores them in the RAM 4 or the storage 10.

Then, the CPU 2 retrieves a surface that has an edge line whose difference to the wall thickness threshold value acquired in step S101 is within a predetermined wall thickness threshold value from all surfaces constituting the part shape, recognizes the retrieved surface as a candidate for side face, and displays the candidate on the display device 8a. After that, the CPU 2 causes the operator to specify an object that the operator wants to add as a side face through the input device 6. At this time, the CPU 2 also causes the operator to specify an object determined as not being a side face by the operator among surfaces recognized as candidates for a side face through the input device 6, thereby removing it from the candidates for a side face. Then, the CPU 2 causes the operator to indicate a confirmation through the input device 6, thereby recognizing and extracting a side face of the part shape (step S102). This processing corresponds to a side-face extracting unit. The side face used here is a surface of a thin-walled shape in its thickness direction and degenerates into a line when a mid-surface is acquired.

Then, in step S103, the CPU 2 partitions the side face recognized in step S102 into a convex surface. This processing corresponds to a convex-shape partitioning unit. The convex surface used here is a surface where a line segment coupling two random vertices forming the surface is present on the boundary of the surface or within the surface. The CPU 2 performs the partitioning by inserting a diagonal line between vertices of a side face. The details of step S103 will be described below with reference to FIG. 23.

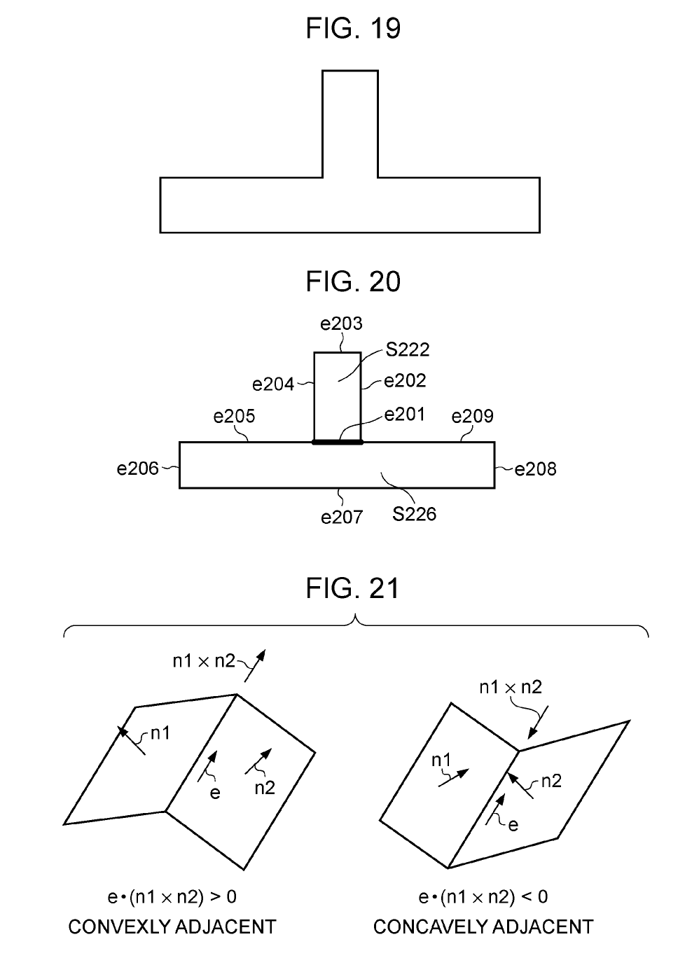

For example, in the case of a side face exhibiting a polygon illustrated in FIG. 19, a diagonal line e201 is inserted between vertices whose interior angle is obtuse, as illustrated in FIG. 20. As a result, the side face illustrated in FIG. 19 is partitioned into a surface S222 and a surface S226. The surface S222 has a sequence of edge liens e201, e202, e203, and e204 as its boundary loop. The surface S226 has a sequence of edge liens e201, e205, e206, e207, e208, and e209 as its boundary loop.

The CPU 2 updates the geometric data such that consistency is maintained in response to the partitioning into a convex shape. During the partitioning into a convex shape, the CPU 2 stores the list including the ID of the newly inserted edge line in the RAM 4 or the storage 10.

After step S103, the CPU 2 extracts any side face of the part shape and retrieves a set of surfaces (surface set) obtained by searching for a surface that is convexly adjacent or adjacent in parallel, starting from the extracted side face (step S104). This processing corresponds to a surface-set acquiring unit. In retrieving a set of surfaces, the CPU 2 does not search for surfaces adjacent through the edge line inserted in step S103. The “convexly adjacent” used here indicates a state in which the expression (1) below is satisfied, as illustrated in FIG. 21.

e·(n1×n2)>0 (1)

where e is a unit vector having a direction of a certain edge line, n1 is a normal vector of a surface left to the direction of that edge line, and n2 is a normal vector of a surface right to the direction of that edge line. The normal vector of a surface used here is a normal vector that faces the outside from the entity of the shape. The normal vector of a surface can be acquired from geometric information for that surface.

In contrast, the state in which the following expression (2) is satisfied is referred to as “concavely adjacent.”

e·(n1×n2)<0 (2)

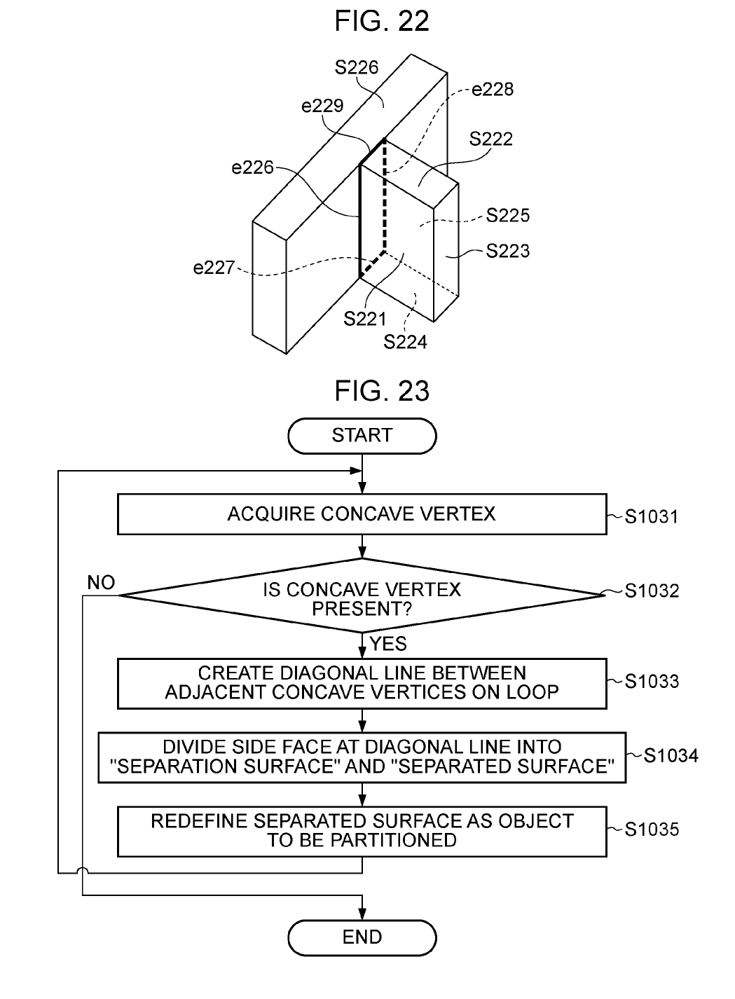

When the CPU 2 cannot search for a more adjacent surface, the CPU 2 stores a list of IDs of edge lines of the boundary of the adjacent surfaces in the RAM 4 or the storage 10 as the list of boundary edge lines. For example, the CPU 2 can retrieve surfaces S222, S223, S224, and S225 from a shape illustrated in FIG. 22, starting from a surface S221. The CPU 2 makes the list of boundary edge lines contain edge lines e226, e227, e228, and e229.

After step S104, the CPU 2 creates a separation boundary loop between the set of surfaces retrieved in step S104 and the remaining set of surfaces (step S105). This processing corresponds to a separation boundary loop extracting unit. That is, starting from a certain edge line, the CPU 2 searches for edge lines having the same vertex and arranges the found edge lines using the list of boundary edge lines stored in step S104. In the example illustrated in FIG. 22, the separation boundary loop is a sequence of edge lines e226, e227, e228, and e229. The separation boundary loop indicates the boundary for each set of surfaces.

Then, in step S106, the CPU 2 determines whether a separation boundary loop of separation in step S105 is present. If there is no separation boundary loop, the CPU 2 determines that there is no partitioned shape to be separated (NO in step S106), the partitioning process is completed. If a separation boundary loop is present (YES in step S106), flow proceeds to step S107.

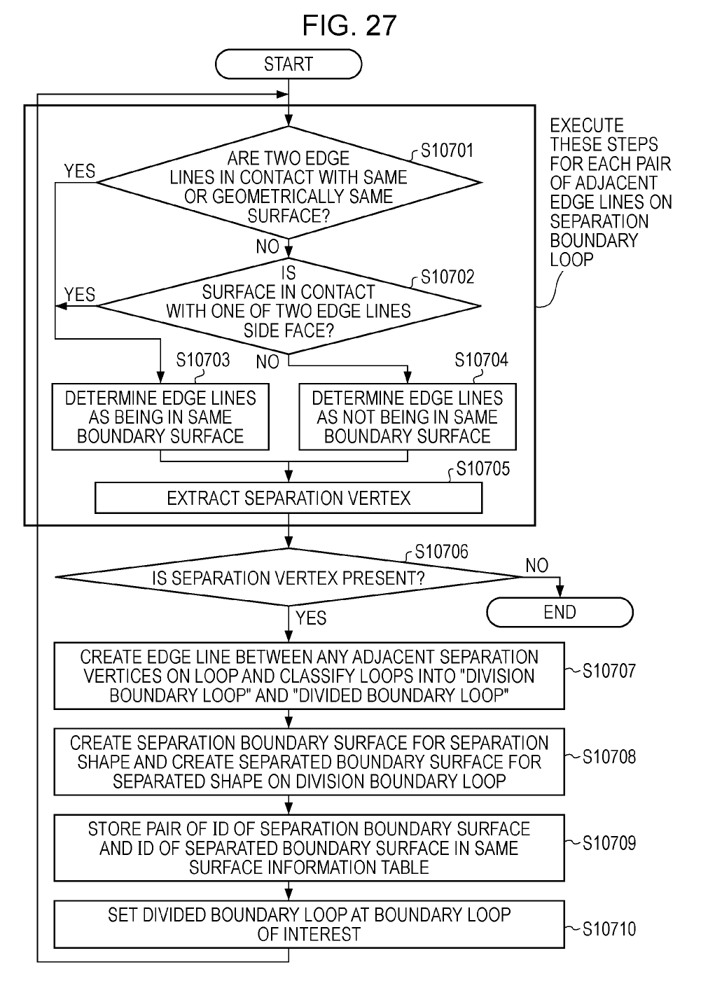

In step S107, the CPU 2 creates a separation boundary surface on the separation boundary loop of the set of surfaces separated in step S104 and a separated boundary surface on the separation boundary loop of the remaining set of surfaces. This processing corresponds to a boundary-surface creating unit. The CPU 2 forms the surfaces into three-dimensional shapes. This processing corresponds to a partitioned-shape generating unit. That separation boundary surface corresponds to a separation boundary surface SB83 illustrated in FIG. 8, and that separated boundary surface corresponds to a separated boundary surface SB84 illustrated in FIG. 8. The details of step S107 will be described below with reference to FIG. 27.

In such a way, the processing in step S1 illustrated in FIG. 2 is completed.

Next, the details of step S103 illustrated in FIG. 18 are described with reference to FIG. 23.

First, in step S1031, the CPU 2 extracts a concave vertex from a side face recognized in step S102 illustrated in FIG. 18. This processing corresponds to a concave-vertex extracting unit. The concave vertex is a vertex at which the relationship between the direction of a tangent, at a vertex of interest, of an edge line before and after the vertex of interest with respect to the direction of rotation of the boundary loop of a surface and the direction of a normal at a vertex of a side face of interest satisfies a condition described below. That is, at the concave vertex, the following expression (3) is satisfied:

e·(d1×d2)<−eps (3)

where d1 is a tangent vector of an edge line before a vertex of interest along the direction of a boundary loop, d2 is a tangent vector of an edge line after the vertex of interest along the direction of the boundary loop, and n is a normal vector at a vertex of a side face.

In contrast, a vertex at which the following expression (4) is satisfied is referred to as a convex vertex.

e·(d1×d2)>eps (4)

In the above expressions, “eps” is a predetermined tolerance and can be stored in, for example, the RAM 4 or the storage 10. The CPU 2 can obtain that value wherever necessary.

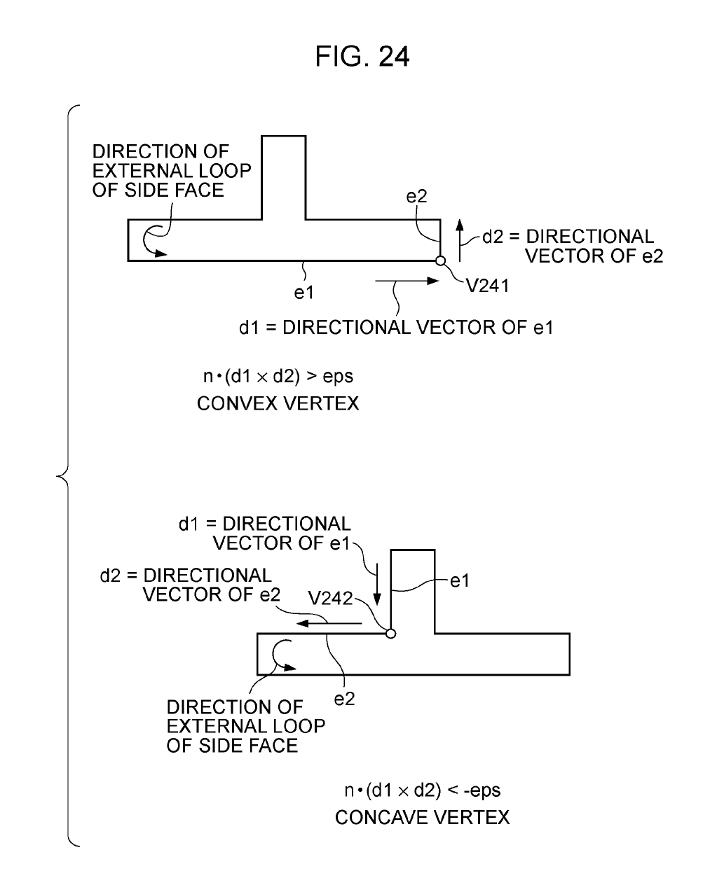

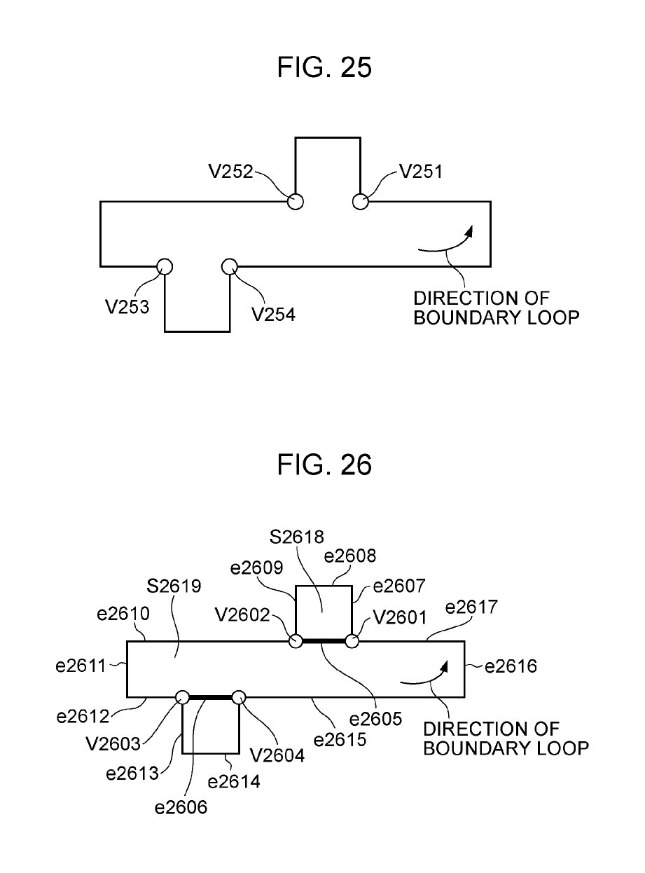

For example, in the example illustrated in FIG. 24, the side face has a normal vector that is perpendicular to the drawing and extending from the drawing toward the direction of a viewpoint. For that side face, a vertex V241 is a convex vertex, and a vertex V242 is a concave vertex. In the example illustrated in FIG. 25, vertices V251, V252, V253, and V254 are extracted as a concave vertex.

After step S1031, the CPU 2 determines whether a concave vertex is present in step S1032. If a concave vertex is not present (NO in step S1032), the partitioning process is finished, and the processing is completed. If a concave vertex is present (YES in step S1032), flow proceeds to step S1033.

In step S1033, the CPU 2 extracts one pair of vertices that are adjacent and are not an end point of the same edge line when the concave vertices extracted in step S1031 are arranged in sequence on the boundary loop of interest and creates a diagonal line between those two vertices. That is, the CPU 2 creates a diagonal line at a predetermined position. This processing corresponds to a diagonal-line creating unit. In the example illustrated in FIG. 26, the CPU 2 extracts concave vertices V2601 and V2602 as one pair of vertices and extracts concave vertices V2603 and V2604 as another pair of vertices. The CPU 2 creates diagonal lines e2605 and e2606 for the respective pairs.

Then, in step S1034, the CPU 2 divides the surface of interest at each of the diagonal lines created in step S1033. This processing corresponds to a side-face dividing unit. The CPU 2 determines a surface that has a boundary containing an edge line from the starting vertex to the ending vertex of the diagonal line along the direction of rotation of the boundary loop as a “separation surface” and determines a surface that has the remaining edge line at the boundary as a “separated surface.” For example, in the example illustrated in FIG. 26, when the diagonal line e2605 is focused, a separation surface S2618 having a boundary loop indicated by a sequence of edge lines e2605, e2606, e2607, e2608, and e2609 is formed, and a separated surface S2619 having a boundary loop indicated by a sequence of edge lines e2605, e2610, e2611, e2612, e2613, e2614, e2615, e2616, and e2617 is formed. The diagonal line e2606 is also processed in the same way. The CPU 2 corrects the geometric data on the newly formed surface, adjacent surface, and edge line such that consistency is maintained.

After that, in step S1035, the CPU 2 redefines the “separated surface” as a surface to be divided. The dividing process from step S1031 to step S1034 is performed again.

In such a way, step S103 illustrated in FIG. 18 is completed.

Next, the details of step S107 are described with reference to FIG. 27.

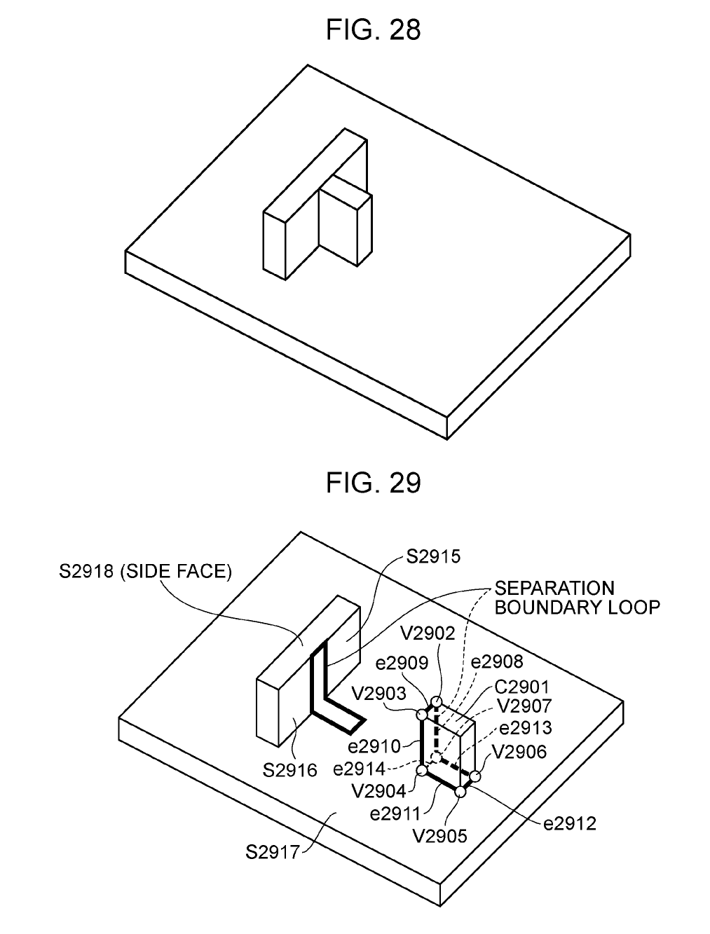

A series of steps S10701 to S10706 is a process for classifying edge lines creating the same separation boundary surface with respect to the separation boundary loop extracted in step S105 illustrated in FIG. 18. That series of steps determines whether the same surface can be placed on each pair of edge lines adjacent on the separation boundary loop. For example, during the process of separating a partitioned shape C2901 illustrated in FIG. 29 from the shape illustrated in FIG. 28, it is necessary to place a separation boundary surface on a separation boundary loop made up of edge lines e2908, e2909, e2910, e2911, e2912, and e2913. For example, it is determined whether the same surface can be placed on the adjacent edge lines e2908 and e2909.

Specifically, first, in step S10701 illustrated in FIG. 27, the CPU 2 determines whether a pair of adjacent edge lines are in contact with the same surface or surfaces having geometrically the same shape in the remaining set of surfaces after separation. If it is determined that the two edge lines are in contact with the same surface or surfaces having geometrically the same shape (YES in step S10701), flow proceeds to step S10703; otherwise (NO in step S10701) flow proceeds to step S10702. For example, in the example illustrated in FIG. 29, both the adjacent edge lines e2911 and e2912 are in contact with a surface S2917 remaining after separation. Thus, it is determined that those two edge lines are in contact with the same surface or surfaces having geometrically the same shape.

In step S10702, the CPU 2 determines whether either one of the pair of adjacent edge lines is an edge line on a side face. If either one is such an edge line (YES in step S10702), flow proceeds to step S10703; otherwise (NO in step S10702), flow proceeds to step S10704. For example, in the example illustrated in FIG. 29, when a surface S2918 is considered as a side face, the edge line e2909 is determined as being on the surface S2918.

In step S10703, the CPU 2 determines that the pair of edge lines being the target of determination in step S10701 or S10702 are in the same boundary surface and that the same surface can be placed on those edge lines. The determination is stored in the RAM 4 or the storage 10.

In step S10704, the CPU 2 determines that the pair of edge lines being the target of determination in step S10701 or S10702 are in different boundary surfaces and that the same surface cannot be placed on those edge lines. The determination is stored in the RAM 4 or the storage 10.

After steps S10703 and S10704, the CPU 2 extracts a vertex between adjacent edge lines on which the same separation boundary surface cannot be placed as a “separation vertex” (step S10705). This processing corresponds to a separation-vertex extracting unit. In the example illustrated in FIG. 29, the same surface cannot be placed on the pair of edge lines e2908 and e2913 and the pair of edge lines e2910 and e2911. Thus, in-between vertices V2907 and V2904 are “separation vertices.”

Then, in step S10706, the CPU 2 determines whether a “separation vertex” has been extracted. If no separation vertex has been extracted (NO in step S10706), the process for dividing the separation boundary loop is completed; otherwise (YES in step S10706), flow proceeds to step S10707.

In such a way, as described above, the CPU 2 classifies edge lines creating the same separation boundary surface.

After that, in step S10707, the CPU 2 creates a division edge line connecting any adjacent separation vertices on the separation boundary loop and divides the separation boundary loop into a “division boundary loop” and a “divided boundary loop.” Specifically, the CPU 2 determines a loop that has no “separation vertex” other than the above-described adjacent separation vertices as a “division boundary loop” and considers the other loops as a “divided boundary loop” along the direction of rotation of the separation boundary loop. That is, the CPU 2 determines a separation boundary loop that has no separation vertex other than the above-described adjacent separation vertices as a “division boundary loop.” This processing corresponds to a separation boundary loop dividing unit. In the example illustrated in FIG. 29, the CPU 2 creates a division edge line e2914 between the “separation vertex” V2907 and “separation vertex” V2904 and divides the loop into a loop made up of the edge lines e2914, e2908, e2909, and e2910 and a loop made up of the edge lines e2914, e2911, e2912, and e2913. In this case, because no “separation vertex” is present on the boundary loop other than the “separation vertices” V2904 and V2907, each of the loops can be set as the “division boundary loop” and “divided boundary loop.”

Subsequently, the CPU 2 duplicates data of the division boundary loop created in step S10707, and determines the original division boundary loop (from which the data is duplicated) as the separation boundary loop for a partitioned shape to be separated and determines the duplicated division boundary loop as the separation boundary loop for a partitioned shape that is to remain after separation. Then, in step S10708, the CPU 2 creates a surface for each of the loops and creates three-dimensional data for each of the partitioned shape to be separated and the partitioned shape that is to remain after separation. This processing corresponds to a separation boundary surface creating unit and a separated boundary surface creating unit. For example, in the example illustrated in FIG. 29, if the loop made up of the edge lines e2914, e2908, e2909, and e2910 is the “division boundary loop,” this “division boundary loop” is duplicated. Then, one of these loops is set as the loop for the partitioned shape C2901 and the other is set as the boundary loop for the partitioned shape remaining after separation. Accordingly, a separation boundary surface and a separated boundary surface similar to the separation boundary surface SB83 and the separated boundary surface SB84 illustrated in FIG. 8, respectively, are created.

Then, in step S10709, the CPU 2 stores a pair of the ID of the “separation boundary surface” and the ID of the “separated boundary surface” created in step S10708 in the RAM 4 or the storage 10.

After that, in step S10710, the CPU 2 sets the “divided boundary loop” at a separation boundary loop to be divided next. Then, steps S10701 to S10709 are performed again.

In such a way, step S107 illustrated in FIG. 18 is completed.

Next, the details of step S5 illustrated in FIG. 2 are described with reference to FIG. 30. The processing from step S501 to step S507 is performed for each “separation boundary surface” created in separating the partitioned shape.

First, in step S5011, the CPU 2 extracts a vertex that exists on a separation boundary surface of interest of an original partitioned shape among vertices of a mid-surface extracted for each partitioned shape. Information indicating whether each vertex exists in a separation boundary surface is generated in the process of extracting a mid-surface, similar to the above-described processing of creating a mesh. Alternatively, the distance between each vertex of the mid-surface and the separation boundary surface of interest may be calculated to determine whether the vertex exists on the surface.

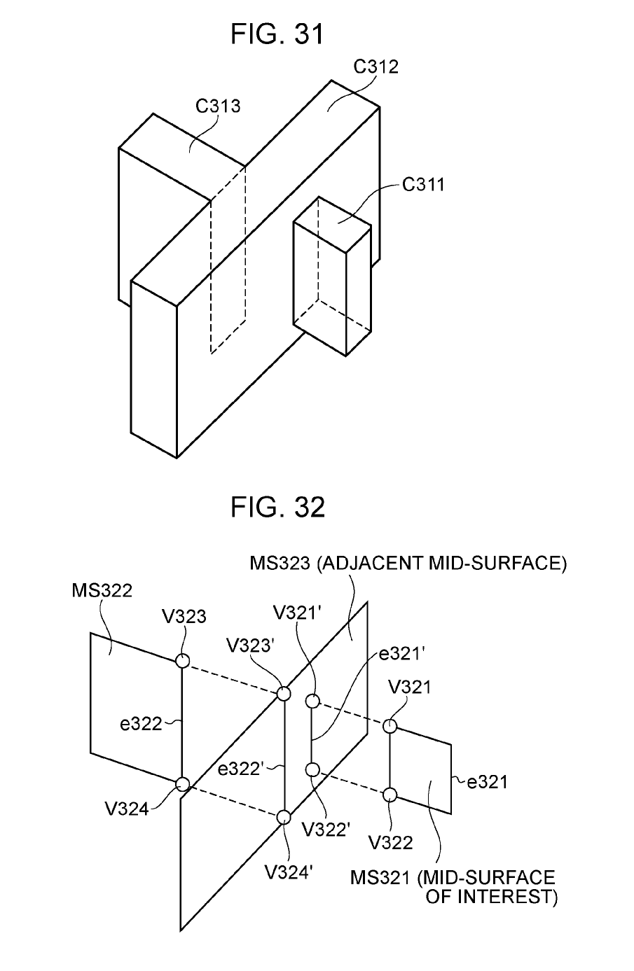

For example, it is assumed that the part shape illustrated in FIG. 31 is divided into partitioned shapes C311, C312, and C313 and, as illustrated in FIG. 32, mid-surfaces MS321, MS322, and MS323 are extracted. Also, it is assumed that the separation boundary surface of interest is the separation boundary surface between the partitioned shapes C311 and C312 and the separation boundary surface exists in the partitioned shape C311. In this case, vertices of the mid-surface MS321 of interest on the separation boundary surface are V321 and V322, and information indicating this is generated in the process of extracting the mid-surface.

After step S5011, the CPU 2 refers to information for the pair of the “separation boundary surface” and “separated boundary surface” created in step S10709 and also refers to a partitioned shape adjacent to the separation boundary surface of interest (step S5012). Then, in step S502, the CPU 2 determines whether the mid-surface of that partitioned shape has been extracted. If no such mid-surface has been extracted (NO in step S502), the processing is completed; otherwise (YES in step S502) flow proceeds to step S503. In the example illustrated in FIGS. 31 and 32, because the partitioned shape C311 adjacent to the mid-surface of interest is adjacent to the mid-surface MS323, it is determined that the mid-surface has been extracted.

In step S503, the CPU 2 projects the vertex on the separation boundary surface extracted in step S501 (separation boundary surface vertex) on the adjacent mid-surface. This processing corresponds to a projected-point generating unit. As described above, in the present embodiment, because it is assumed that all of the edge lines is a line segment, a sequence of line segments that couple the projected vertices is a sequence of projected edge lines. In the example illustrated in FIG. 32, the points obtained by projecting the vertices V321 and V322 of the separation boundary surface of interest on the adjacent mid-surface MS323 are V321′ and V322′. The edge line e321′ coupling the vertices V321′ and V322′ is a projected edge line of the edge line e321 connecting the vertices V321 and V322.

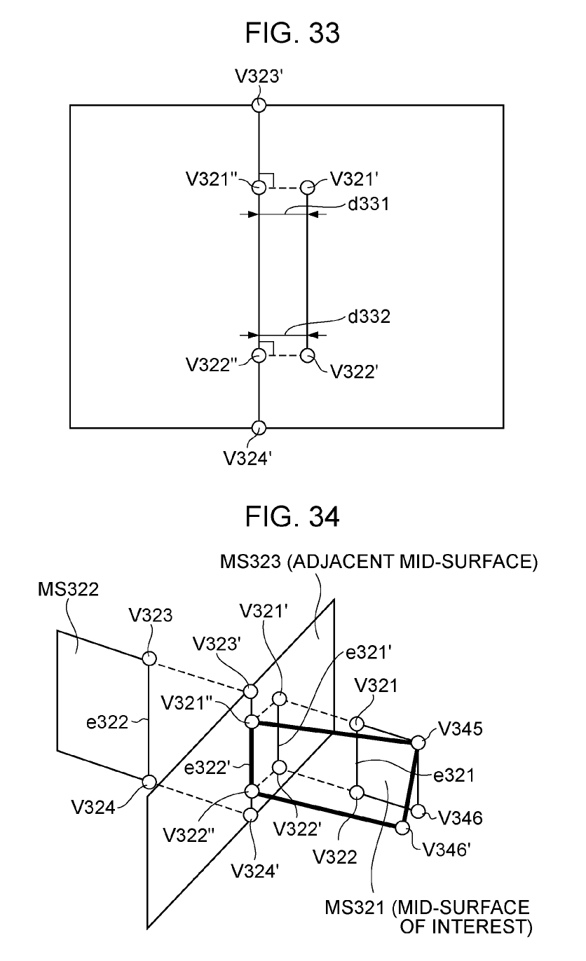

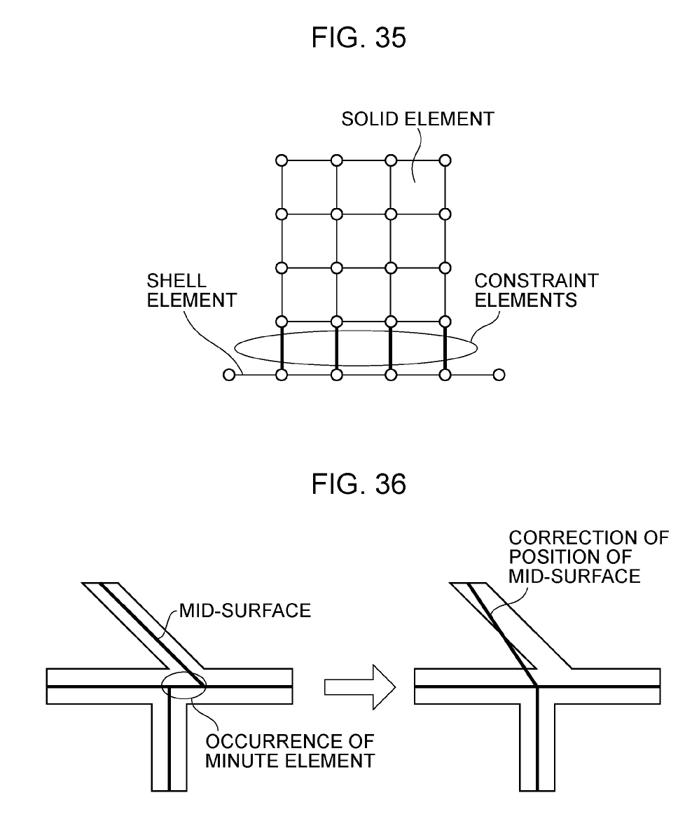

Then, in step S504, if another previously projected edge line is present in the adjacent mid-surface, the CPU 2 determines whether the newly projected vertex on the separation boundary surface is near that edge line. The determination can be made based on whether the distance between each vertex and the previously projected edge line is smaller than a threshold set by an operator. If they are near each other (YES in step S504), flow proceeds to step S505; otherwise (NO in step S504) flow skips step S505 and moves to step S506. If they are near each other, there is a possibility that a small element occurs in creating a mesh for a combined mid-surface. For example, in the example illustrated in FIG. 32, because a projected edge line e322′ of the adjacent mid-surface MS322 is already present in the adjacent mid-surface MS323, as illustrated in FIG. 33, the distance d331 between a projected point V321′ and the projected edge line e322′ is calculated, and it is determined whether the calculated distance is smaller than a threshold set by an operator.

In step S505, the CPU 2 moves the newly projected vertex to the previously projected edge line. This processing corresponds to a second projected-point correcting unit and a vertex correcting unit. In this movement, the CPU 2 calculates the shortest line between the vertex of interest and the edge line and moves the vertex of interest to the foot of the shortest line on the edge line. If the distance (gap) between the moved point and any one of vertices of the edge line is equal to or smaller than a threshold (predetermined value) set by an operator, that vertex is made to be the projected point. For example, in the example illustrated in FIG. 33, because the projected point V321′ is near the projected edge line e322′, the position of the projected point V321′ is moved to the position of a foot V321′ ′ of the shortest line on the edge line e322′ from the projected point V321′. If the distance between the foot V321′ ′ and the vertex V323′ is smaller than a threshold, the position of the foot V321′ ′ is further moved to the position of the vertex V323′. Similar processing is performed on the projected point V322′. Then, flow proceeds to step S506. When, other than a projected point, another projected point generated from another mid-surface is present, if the distance between these projected points is equal to or smaller than a predetermined value, it is useful that one of the projected points (projected vertex) be selected and the position of the other remaining projected point be corrected so as to be moved to the position of the selected projected point. This processing corresponds to a projected-point correcting unit and a vertex correcting unit.

In step S506, the CPU 2 moves the position of the vertex on the separation boundary surface to the position of the projected vertex. At this time, the CPU 2 changes the position and the orientation of the mid-surface of the partitioned shape of interest such that consistency is maintained. For example, in the example illustrated in FIG. 34, the position of the vertex V321 is moved to the position of the projected point V321′, and the position of the vertex V322 is moved to the position of the projected point V322′. If the projected point is moved in step S505, the vertex is moved to the moved position. As a result of moving the projected point, there is a possibility that the moved projected points V321′ and V322′ and the vertices V345 and V346 on the original mid-surface MS321 are not on the same plane. In this case, for example, the vertex V346 is moved to the position of a point V346′ obtained by projecting the vertex V346 on the plane defined by the projected points V321′ and V322′ and the vertex V345.

In step S507, the CPU 2 registers information on the above projected edge line for each mid-surface and allows the information to be utilized in the above-described processing.

In such a way, step S5 illustrated in FIG. 2 is completed.

With the present embodiment, a composite analysis model that includes both a shell mesh and a solid mesh for use in the finite element method can be easily generated from CAD information for a thin-walled part (e.g., sheet-metal part and injection mold) using a small number of man-hours. That is, because, after mid-surfaces of partitioned shapes in which a shell is set are appropriately combined, a shell mesh and a solid mesh are integrated, a composite analysis model that includes both a shell mesh and a solid mesh can be easily generated. Accordingly, an analysis model can be easily generated even for a thin-walled part having a complex shape.

Even when a small element would be present, the small element can be eliminated in advance by correction of a projected point, so the calculation time can be prevented from being significantly increased. Alternatively, the number of man-hours for correcting a model such that no small element is present by an operator can be reduced.

With the present embodiment, because a part shape is partitioned into partitioned shapes on the basis of a CAD model of the part, the number of man-hours that an operator must perform can be reduced. For example, the number of man-hours for partitioning a side-face shape into a convex shape being a portion of the process for partitioning a part shape into partitioned shapes can be reduced. Moreover, because adjacent relationship is stored in integrating mid-surfaces extracted from partitioned shapes and integrating a shell mesh and a solid mesh obtained by modeling from partitioned shapes, the necessity for an operator to provide an instruction in this model integrating process can be eliminated. Thus, the number of man-hours can be reduced. Because information for identifying a boundary surface to be separated is generated in separating the partitioned shapes, the number of man-hours of an operator can be reduced.

The present embodiment of the present invention can be achieved by a computer executing a program, for example. A medium for supplying a program to a computer can also be applied as the present embodiment of the present invention. Examples of such a medium include a computer-readable storage medium (e.g., a compact-disk read-only memory (CD-ROM) storing the program and a transmission medium (e.g., the Internet) that transmits the program. The program is also applicable as the present embodiment of the present invention. The program, the storage medium, the transmission medium, and a program product can be included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-117543 filed Apr. 28, 2008, which is hereby incorporated by reference herein in its entirety.

What is claimed is:

1. An apparatus for generating an analysis model, the apparatus comprising:
a partitioning unit configured to partition a shape of an analysis target into multiple partitioned shapes using CAD information data for the analysis target;
an adjacent-relationship information generating unit configured to generate adjacent-relationship information indicating an adjacent relationship between the multiple partitioned shapes;
a setting unit configured to set a modeling type for each of the multiple partitioned shapes;
a mid-surface extracting unit configured to extract a mid-surface for a partitioned shape in which a shell is set as the modeling type by the setting unit;
an integrating unit configured to refer to the adjacent-relationship information and integrate two or more mid-surfaces extracted from adjacent partitioned shapes into a combined mid-surface;
a shell-mesh creating unit configured to create a shell mesh for the combined mid-surface;
a solid-mesh creating unit configured to create a solid mesh for a partitioned shape in which a solid is set as the modeling type by the setting unit; and
an inserting unit configured to refer to the adjacent-relationship information and insert constraint elements that link a shell mesh and a solid mesh that are adjacent to each other.

2. The apparatus for generating an analysis model according to claim 1, wherein the integrating unit includes a mid-surface correcting unit configured to correct positions of mid-surfaces constituting the combined mid-surface.

3. The apparatus for generating an analysis model according to claim 2, wherein mid-surface correcting unit includes a projected-point generating unit, a projected-point correcting unit, and a vertex correcting unit,
wherein the projected-point generating unit is configured to, among vertices of a first mid-surface of the mid-surfaces, project a separation boundary surface vertex on a second mid-surface with which the first mid-surface is integrated, the separation boundary surface vertex being present in a separation boundary surface generated on the multiple partitioned shapes together with the partitioning performed by the partitioning unit, and to generate a projected point,
the projected-point correcting unit is configured to, when another projected point generated from another mid-surface is present within the second mid-surface at which the projected point is generated, if a distance between the projected points is equal to or smaller than a predetermined value, perform correction such that the projected points are located at a position of one of the projected points, and
the vertex correcting unit is configured to perform correction such that the separation boundary surface vertex is located at the position of the projected point.

4. The apparatus for generating an analysis model according to claim 3, wherein the mid-surface correcting unit further includes a second projected-point correcting unit configured to, when a projected edge line obtained by projecting an edge line of another mid-surface is present within the second mid-surface at which the projected point is generated, if a distance between the projected point and the projected edge line is equal to or smaller than a predetermined value, perform correction such that the projected point is located in the projected edge line.

5. The apparatus for generating an analysis model according to claim 1, wherein the partitioning unit includes a side-face extracting unit, a convex-shape partitioning unit, a surface-set acquiring unit, a separation boundary loop extracting unit, a boundary-surface creating unit, and a partitioned-shape generating unit,
wherein the side-face extracting unit is configured to extract a side face of the analysis target,
the convex-shape partitioning unit is configured to partition the side face into a convex-shape surface,
the surface-set acquiring unit is configured to acquire a set of surfaces retrieved by searching for side faces that exist before the partitioning performed by the convex-shape partitioning unit and that are in a convex or parallel relationship from side faces of the analysis target,
the separation boundary loop extracting unit is configured to extract a separation boundary loop indicating a boundary for each set of surfaces,
the boundary-surface creating unit is configured to create, on the separation boundary loop, a separation boundary surface for a first set of surfaces and a separated boundary surface for a second set of surfaces, and
the partitioned-shape generating unit is configured to, for each set of surfaces, generate a partitioned shape having a surface forming the set of surfaces and having one of the separation boundary surface and the separated boundary surface.

6. The apparatus for generating an analysis model according to claim 5, wherein the convex-shape partitioning unit includes a concave-vertex extracting unit, a diagonal-line creating unit, and a side-face dividing unit,
wherein the concave-vertex extracting unit is configured to extract a concave vertex between concavely adjacent edge lines within the side face,
the diagonal-line creating unit is configured to create a diagonal line between adjacent concave vertices of the side face on the separation boundary loop, and
the side-face dividing unit is configured to divide the side face at the diagonal line into the convex-shape surface.

7. The apparatus for generating an analysis model according to claim 5, wherein the adjacent-relationship information generating unit is configured to cause information that identifies a combination of the separation boundary surface and the separated boundary surface and information that identifies a partitioned shape containing the separation boundary surface and a partitioned shape containing the separated boundary surface to be included in the adjacent-relationship information.

8. The apparatus for generating an analysis model according to claim 5, wherein the boundary-surface creating unit includes a determining unit, a separation-vertex extracting unit, a separation boundary loop dividing unit, a duplicating unit, a separation boundary surface creating unit, and a separated boundary surface creating unit,
wherein the determining unit is configured to determine that surfaces containing a pair of adjacent edge lines on the separation boundary loop form the same boundary surface at least one of when the pair of adjacent edge lines are adjacent to the same surface, when surfaces adjacent to the pair of adjacent edge lines are geometrically the same, and when a surface adjacent to either one of the pair of adjacent edge lines is a side face,
the separation-vertex extracting unit is configured to extract a vertex between edge lines forming different boundary surfaces as a separation vertex,
the separation boundary loop dividing unit is configured to create an edge line between two adjacent separation vertices on the separation boundary loop, divide the separation boundary loop, and determine a separation boundary loop that has no separation vertex other than the two adjacent separation vertices as a division boundary loop,
the duplicating unit is configured to duplicate the division boundary loop,
the separation boundary surface creating unit is configured to create a separation boundary surface on the division boundary loop before the duplicating performed by the duplicating unit, and
the separated boundary surface creating unit is configured to create a separated boundary surface on the division boundary loop generated by the duplicating performed by the duplicating unit.

9. A method for generating an analysis model, the method comprising:
partitioning a shape of an analysis target into multiple partitioned shapes using CAD information data for the analysis target;
generating adjacent-relationship information indicating an adjacent relationship between the multiple partitioned shapes;
setting a modeling type for each of the multiple partitioned shapes;
extracting a mid-surface for a partitioned shape in which a shell is set as the modeling type;
referring to the adjacent-relationship information and integrating two or more mid-surfaces extracted from adjacent partitioned shapes into a combined mid-surface;
creating a shell mesh for the combined mid-surface;
creating a solid mesh for a partitioned shape in which a solid is set as the modeling type; and
referring to the adjacent-relationship information and inserting constraint elements that link a shell mesh and a solid mesh that are adjacent to each other.

10. A storage medium that stores a computer-readable program allowing a method for generating an analysis model according to claim 9 to be achieved using a computer.
